(19) United States
(12) Patent Application Publication
(10) Pub. No.: US 2007/0079676 A1
(43) Pub. Date: Apr. 12, 2007

(54) Paper dispenser

(75) Inventors: Matthew Friesen, Surrey (CA); John Friesen, Vancouver (CA); Brad Friesen, Vancouver (CA)

Correspondence Address: KLARQUIST SPARKMAN, LLP, 121 SW SALMON STREET, SUITE 1600, PORTLAND, OR, 97204, US

(73) Assignee: Global Plastics

(21) Appl. No.: 11/245,585

(22) Filed: Oct. 7, 2005

(51) Int. Cl. B23D 25/02

(52) U.S. Cl. 83/37

(57) ABSTRACT

A hand-free paper dispensing device is provided that is particularly suitable for the away-from-home market. The dispensing device comprises a rotatable drum having a transversely-extending rolling surface for receiving a paper sheet thereon and a retractable knife configured to extend out of the drum at a first rotational position. The dispensing device also comprises a paper guide for guiding the paper sheet onto the rolling surface; the paper guide has a plurality of transversely-spaced ribs having a radial spacing from the rolling surface at the first rotational position that is less than the radial distance of the knife when extended at the first rotational position. Such an arrangement ensures that a paper towel segment is cut at each revolution of the drum, thereby reducing the incidence of paper double-sheeting.

### FIELD

This invention relates generally to paper dispensers and particularly to away-from-home type paper towel dispensers.

### BACKGROUND

Different types of single-use paper towel dispensers are available for the away-from-home market. For example, folded paper towel dispensers contain a stack of folded individual paper towel segments that are dispensed through a slot. Other dispensers dispense paper towel segments from a tightly wound paper roll. Such dispensers can dispense paper towel segments from perforated or continuous paper rolls. Perforated roll dispensers contain a continuous paper roll with longitudinally-spaced, transversely-extending perforations that define individual paper towel segments. In continuous roll dispensers, a continuous paper roll is cut into individual segments by a cutting device located in the dispenser.

There are continuous roll dispensers which require a user to sever a paper segment from the continuous roll by pulling the paper against a serrated cutting blade. Such dispensers cannot control the length of the paper segment dispensed, and are thus susceptible to paper wastage. Another type of continuous roll dispenser is known as a portion control dispenser, which automatically cuts the paper roll into paper towel segments as the paper is being dispensed from the dispenser. In one type of portion control dispenser, the paper roll is rotatably mounted inside the dispenser and a leading edge of the paper is fed through a cutting roller and out of the dispenser through a slot. When a user pulls on the leading edge of the paper, the cutting roller rotates and a knife in the cutting roller extends radially outwards and punctures the paper, thereby severing a paper towel segment from the roll. The dispenser is designed to cut the paper into segments of defined length and only one at a time, thereby reducing paper wastage.

The continuous roll portion control dispenser can be a “hands-free” (touchless) type, i.e. designed to dispense paper towel segments without requiring the user to touch any part of the dispenser other than the leading edge of the paper roll. Such a design is particularly desirable as the user is not exposed to germs or contaminants on other parts of the dispenser.

Problems arise with known hands-free portion-control dispensers when a user pulls strongly on the paper towel roll. When pulled too strongly, the cutting knife sometimes fails to puncture the paper, resulting in “double sheeting” wherein a double-length paper segment is dispensed. Also, a strong pull on the paper can cause the towel roll to overspin, resulting in unrolled and uncut paper filling the inside of the dispensers and causing jamming.

Known attempts for prevent overspinning include incorporating a mechanical stopper mechanism in the cutting roller, which stops the roller after a single revolution. Such mechanical stoppers tend to be quite noisy and can wear out prematurely.

### SUMMARY

The present disclosure concerns embodiments of a hands-free portion control paper towel dispenser that improves upon existing such dispensers, and in particular, reduces incidence of double-sheeting and paper jamming, is quiet in operation and is unaffected by overspin.

In particular embodiments, there is provided a hand-free paper dispensing device that is particularly suitable for the away-from-home market. The dispensing device comprises a rotatable drum having a transversely-extending rolling surface for receiving a paper sheet thereon and a retractable knife configured to extend out of the drum through part of the drum's rotation. The dispensing device also comprises a paper guide for guiding the paper sheet onto the rolling surface; the paper guide has a plurality of transversely-spaced ribs that are radially spaced from the rolling surface and radially overlap with the knife when the knife is fully extended (“radially” means the radial direction from the drum axis). Such an arrangement ensures that a paper towel segment is cut at each revolution of the drum, thereby reducing the-incidence of paper double-sheeting. The rotational drag on the drum caused by each cut and/or by the close proximity and relationship of the paper guide to the drum serves to slow the drum to a stop without the need for a mechanical stopper, which tends to be noisy in operation.

The knife can be a saw tooth knife; in such case, at least some of the ribs extend into valleys of the saw tooth knife when the knife is fully extended. Alternatively, the knife can comprise notches; in such case, at least some of the ribs extend into the notches when the knife is fully extended; these notches can be present in the saw tooth knife. As another alternative, the knife can comprise multiple transversely-spaced segments wherein at least some of the ribs extend into the spaces between the segments when the knife is fully extended.

The ribs can extend lengthwise over the part of the drum's rotation wherein the knife is extended. For convenient reference, the knife initially extends out of the drum when the drum is in a first rotational position, then becomes fully extended when the drum reaches a second rotational position, then finally retracts back into the drum when the drum reaches a third rotational position. Some ribs can be deeper than others. Some ribs can extend into valleys in the drum as well as valleys in the knife blade.

The radial spacing between the drum and rolling surface can vary along the length of at least one of the ribs. In particular, the radial spacing can be at a maximum at the second rotational position, and at a minimum at the first rotational position. Such variable radial spacing is useful to allow sufficient space for the knife to fully extend as the drum rotates from the first to second radial position. The minimum spacing at the first rotational position is also useful to reduce the tendency for paper to bunch up in the radial spacing between the ribs and the rolling surface, thereby reducing the tendency for paper jamming.

According to another embodiment, there is provided a method of dispensing paper towel segments comprising:
guiding a paper towel sheet onto a rolling surface of a cutting drum;
rotating the drum and extending a knife out of the drum until the knife radially overlaps with ribs radially spaced from the rolling surface and the sheet is punctured by the knife; then
further rotating the drum until a paper towel segment severed from the sheet by the knife is dispensed.

The ribs serve to hold the paper in a radial position close to the drum while the knife extends out of the drum and punctures the paper. When a saw tooth knife is used, the ribs extend into the valleys of the saw tooth knife. Without these ribs, the knife blade can push the paper away from the drum, without completing the cut.

### BRIEF DESCRIPTION OF THE DRAWINGS

FIG. 1 is a perspective view of a hands-free paper towel dispenser according to one embodiment of the invention.

FIG. 2 is a perspective view of the dispenser with its front housing opened.

FIG. 3 is a perspective, partially disassembled view of the dispenser, illustrating the front and back housings and internal components in assembled form.

FIG. 4 is a perspective, partially disassembled view of some of the internal components of the dispenser.

FIG. 5 is a perspective partially disassembled view of a cutting drum assembly of the dispenser.

FIGS. 6(a) and (b) are transparent side views of the dispenser, with the cutting drum in a starting position (FIG. 6(a)), and in a cutting position (FIG. 6(b)).

FIG. 7 is a perspective partial view of the cutting drum assembly.

FIG. 8 is a schematic front elevation view of parts of the paper guide and cutting drum assembly, wherein the cutting knife is fully deployed from the drum assembly.

### DETAILED DESCRIPTION

Directional terms such as “top”, “bottom”, “right”, and “left” are used in this description merely to aid in describing the embodiments of the dispenser and are not to be construed as limiting the embodiments to any particular orientation during operation or in connection to another apparatus.

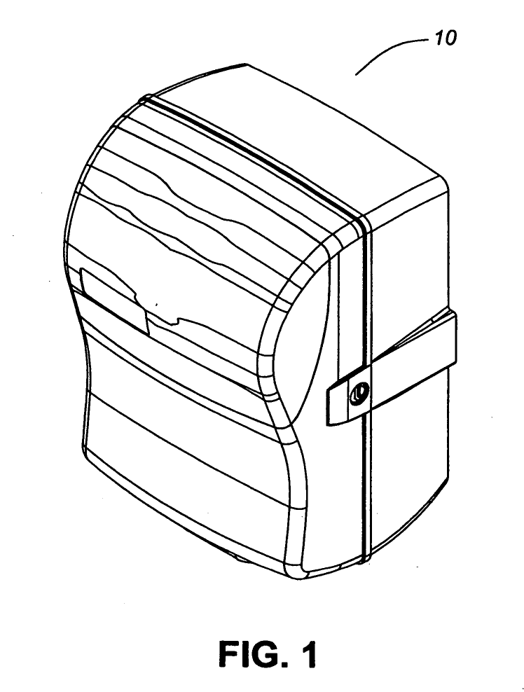

According to one embodiment and referring to FIG. 1, a hands-free paper towel dispenser 10 is provided for dispensing paper towel segments in a quiet manner and with a reduced tendency to double-sheet and jam.

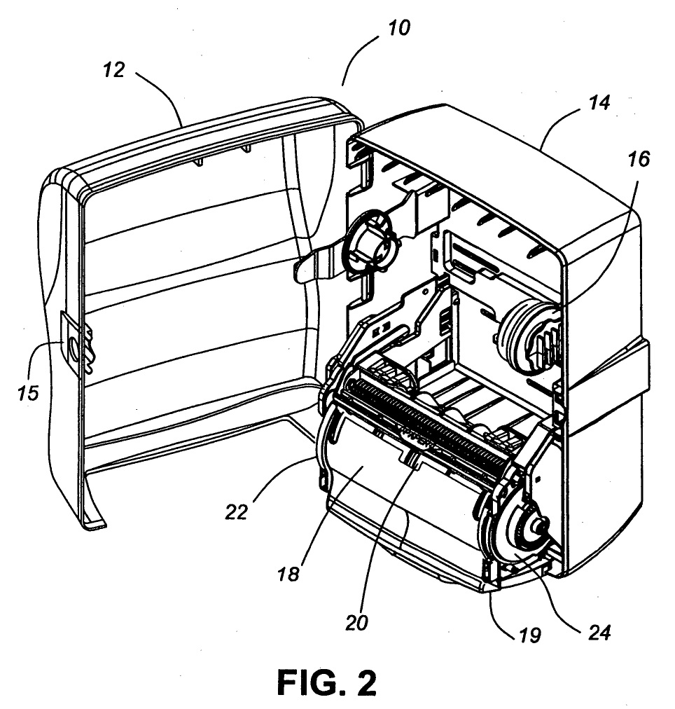

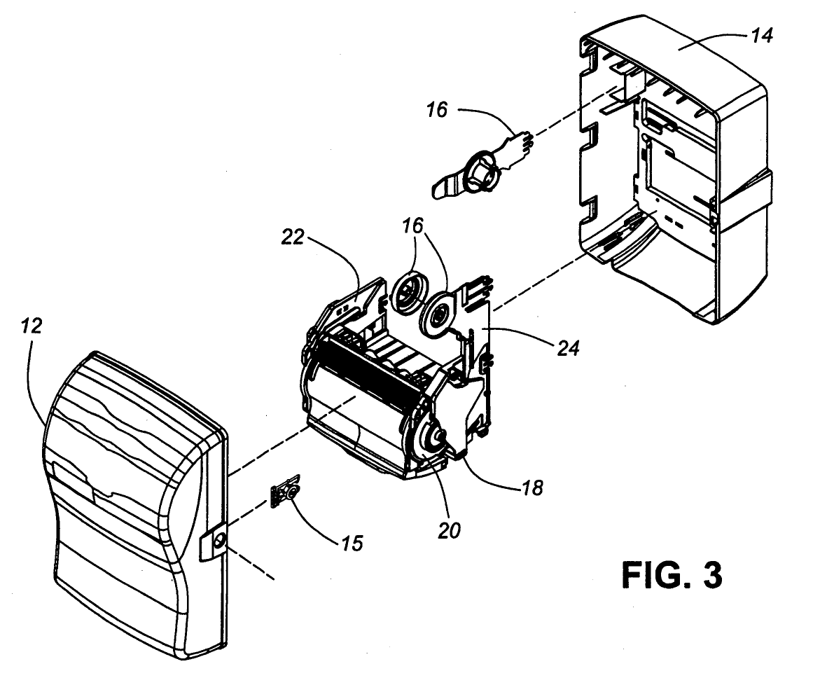

Referring to FIGS. 2 and 3, the dispenser has a housing comprising a front housing 12 and a rear housing 14; the two housings 12, 14 are hingedly interconnected, enabling the front housing 12 to be swung open to reveal the internal components of the dispenser 10. A locking mechanism 15 is provided to lock the two housings 12, 14 together. The dispenser 10 dispenses paper towel segments cut from a paper towel roll (not shown) rotatably mounted on a roll holder 16 at an upper portion inside the dispenser 10. The leading edge of the paper roll is threaded through a roller assembly 18 mounted at a lower portion inside the dispenser 10 and out of the dispenser 10 through a paper slot 19 at the bottom of the dispenser 10.

The roller assembly 18 comprises a cutting drum 20 rotatably coupled to left and right side panels 22, 24. As a user pulls the leading edge of the paper roll through the slot 19, the cutting drum 20 rotates and severs a paper towel segment from the roll.

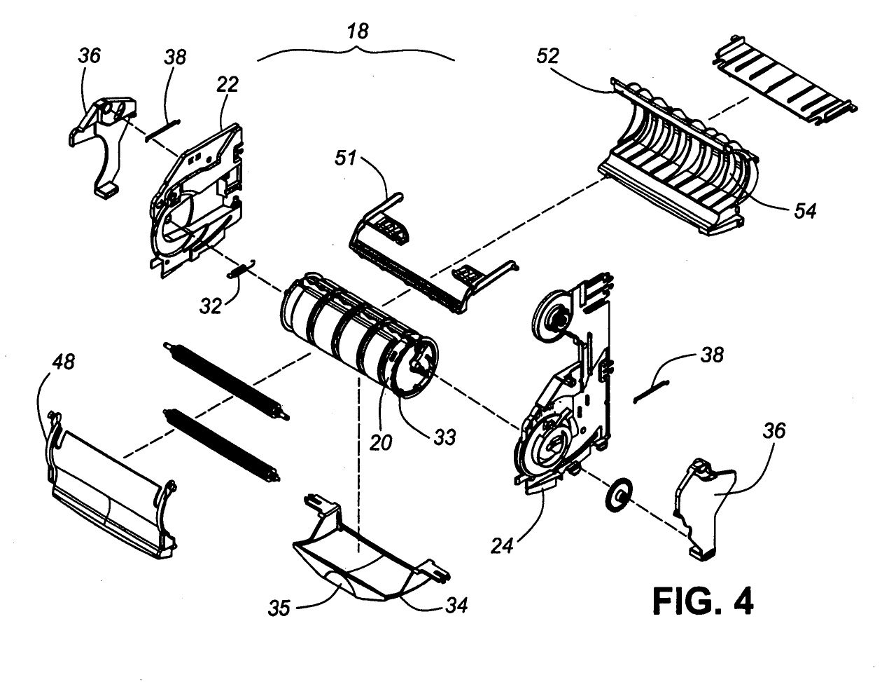

Referring to FIG. 4, the roller assembly 18 comprises a number of parts which collectively serve to feed the paper roll from the roll holder 16 to the slot 19, and cut the paper roll into uniform sized paper towel segments. Of particular note, the roller assembly 18 relies on rotational drag created during the cutting operation to stop the rotation of the cutting drum 20 after a single paper towel segment has been dispensed, instead of a mechanical stop, which tends to be noisy and prone to wear and failure.

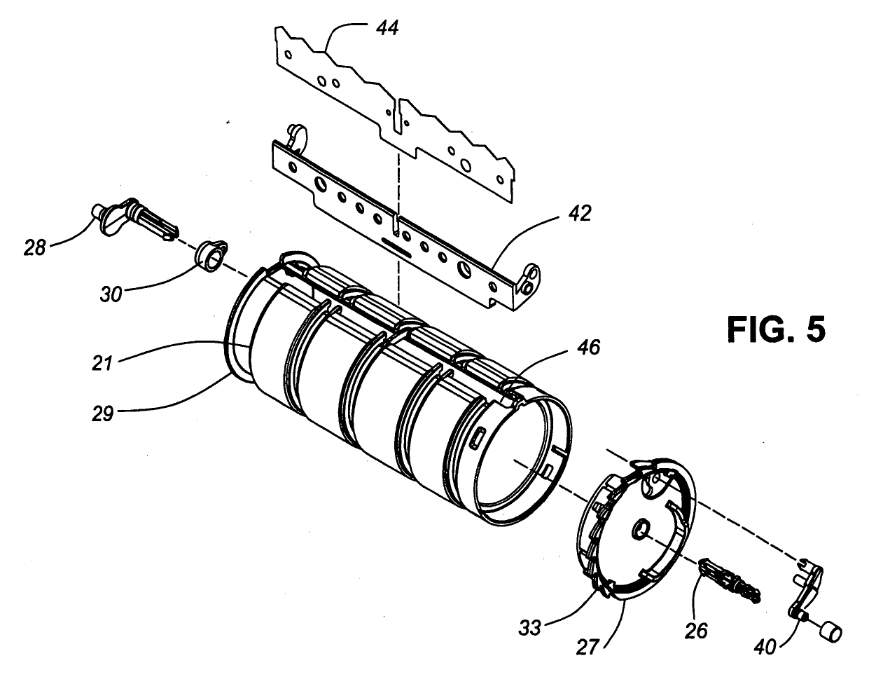

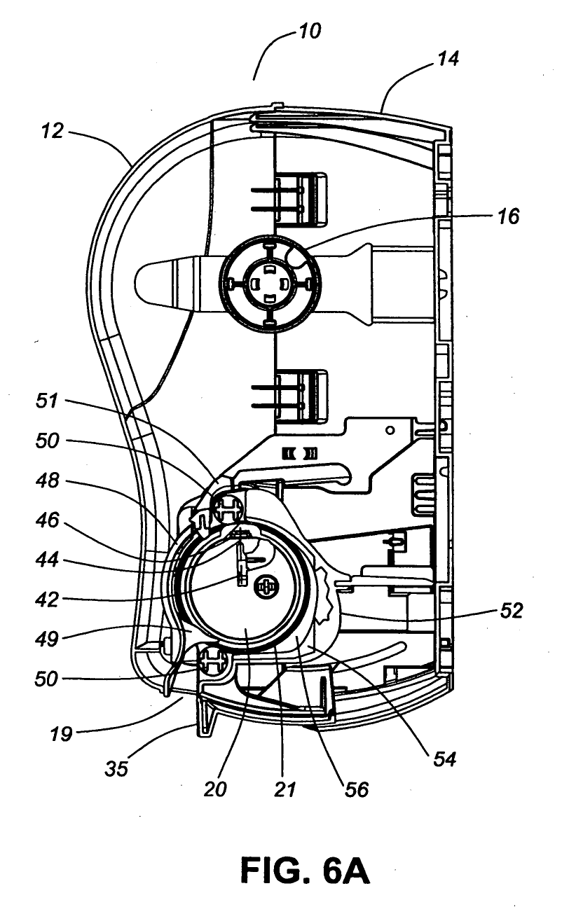

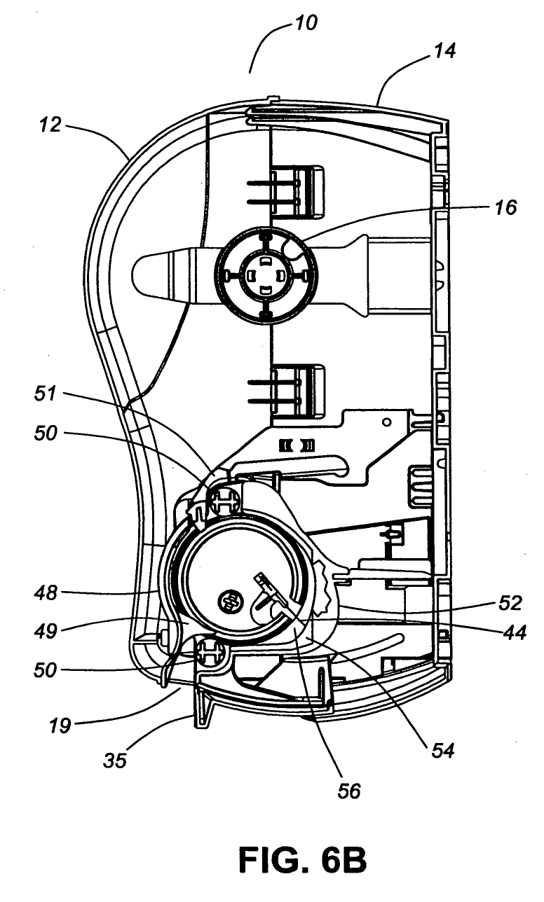

Referring to both FIGS. 4 and 5, the cutting drum 20 comprises a cylindrical rolling surface 21 and right and left end caps 27, 29. A drum pin 26 is mounted to the right end cap 27 and to the right side panel 24. A crank arm 28 is mounted to a left end cap 29 of the cutting drum 20 and to the left side panel 22. The crank arm 28 includes a crank bushing 30 mounted off the drum axis, and attaches to one end of a return spring 32; the other end of the return spring 32 attaches to the left side panel 22. The return spring 32 serves to rotate the cutting drum 20 enough to advance the leading edge of the paper roll through the slot 19 that the user can easily grasp the paper. Because the crank bushing 30 is mounted off the drum axis, rotation of the drum (e.g. caused by the user pulling on the paper) loads up the spring 32 until the spring 32 passes a top dead centre position wherein the spring's longitudinal axis extends through the drum centreline. When the spring 32 passes the top-dead centre position, the spring 32 releases its stored energy and rotates the drum 20 until the spring energy is fully released, and positions the drum 20 in a start position (see FIG. 6(a)).

The right end cap 27 includes circumferentially-disposed teeth 33 which engage with a manual advance assembly 34. The manual advance assembly 34 comprises a push button 35 connected at either end to left and right advance levers 36. The right advance lever 36 engages the teeth 33; when a user pushes the push button 35, the lever 36 rotates the cutting drum 20 a rotation proportional to the push stroke. Such manual advance is useful when an insufficient amount of paper extends from the slot 19. Manual advance springs 38 serve to return the advance assembly 34 back to its start position.

A knife actuator 40 extends from the right end cap 27 (off-drum axis) and engages a cam path (not shown) located in the right side panel 24. The knife actuator 40 is coupled to a knife holder 42, which holds a saw-tooth cutting knife 44 having multiple teeth that extend across the width of the knife 44. The knife holder 42 is pivotally coupled to the rim of the right and left end caps 27, 29 such that the knife holder 42 and knife 44 can be pivoted between a retracted position inside the cutting drum 20 (see FIG. 6(a)), and an extended position wherein the knife extends radially out of the rolling surface 21 through a knife slot 46 (see FIG. 6(b)).

Referring now to FIGS. 4, 6(a) and 6(b), a front cover 48 is mounted to the left and right side panels 22, 24 in front of the cutting drum 20. The front cover 48 has an inside surface facing the rolling surface 21. Fingers 49 protrude from the inside surface and terminate close to rolling surface 21; the fingers 49 separate the paper from the rolling surface 21 and direct the paper downwards through the slot 19. Top and bottom pinch roller 50 are rotatably mounted to the left and ride side panels 22, 24, and serve to guide the paper into and out of the roller assembly 18. A transfer mechanism 51 is pivotally attached to the left and right panels 22, 24 and serves to transfer paper from a stub roll into the roller assembly 18, in a manner well known in the art.

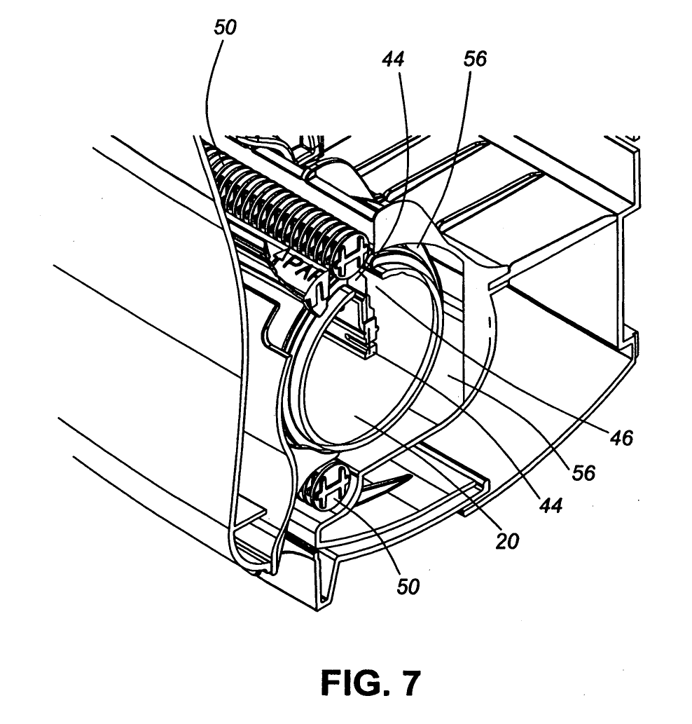

A paper guide 52 is mounted to the left and right side panels 22, 24 behind the cutting drum 20. The paper guide 52 comprising a plurality of ribs 54 facing the rolling surface 21, that serve to keep the paper from “bunching up” between the paper guide 52 and rolling surface 21, and to hold the paper in place for cutting by the cutting knife 44. The ribs 54 are transversely spaced and span the width of the cutting drum 20; the spaces in between the ribs 54 are hereby defined as “rib cavities” 55. The ribs 54 are curved and generally conform to the curvature of the rolling surface 21: The radial spacing between the ribs 54 and rolling surface 21 is at a minimum at the top of the paper guide 52, which is located at the start position of the cutting knife 44 (shown in FIG. 6(a)), and hereby referred to as the “0 degree” position. The radial spacing widens to a maximum at around 135 degrees from the start position, then narrows to the minimum at the bottom of the paper guide 52, i.e. at the finish position around 180 degrees from the start position. This spacing between the start and finish positions is hereby referred to as a “cutting zone” 56, and serves to provide sufficient space for the cutting knife 44 to extend out from the cutting drum 20 but insufficient space for the paper to bunch up. When the cutting drum 20 rotates (clockwise in FIGS. 6(a) and (b)), the knife actuator 40 moves through the cam path, which is configured to cause the knife actuator 40 to pivot and extend the cutting knife 44 through the rolling surface opening 46 when the knife 44 passes through the cutting zone 56 (as shown in FIG. 6(b)), and retracts the knife 44 when the cutting drum 20 rotates out of the cutting zone 56 (as shown in FIG. 6(a)). The cutting zone 56 is shown in detail in FIG. 7.

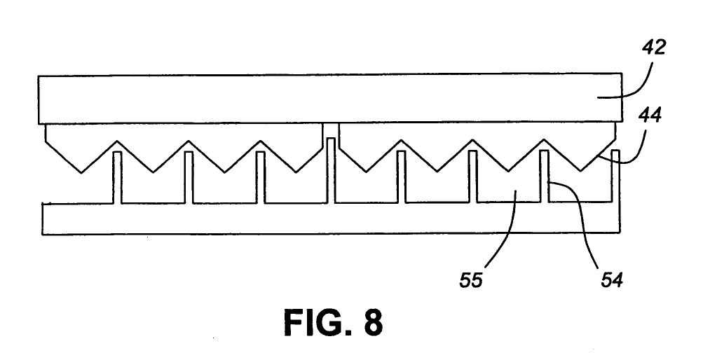

When the cutting knife 44 is fully extended and as shown in FIG. 8, the knife teeth (i.e. the tips of the saw-tooth knife 44) extend between the ribs 54 and into the rib cavities 55 in between the ribs 54, and the ribs 54 extend into the valleys between the knife teeth. In other words, the ribs 54 and knife teeth overlap in the drum's radial direction when the knife 44 is fully extended. Note that the radial extension of the knife 44 is less than the knife's lengthwise extension out of the drum 20, since the knife 44 pivots out of the drum 20 at an angle to the drum's radial direction. This angle increases the further the knife pivots out of the drum 20.

When the knife 44 extends into the cutting zone 56, the knife 44 contacts the paper therein. If the knife 44 is extending with sufficient momentum, the knife teeth will puncture the paper upon contact, and a paper towel segment will be severed from the paper roll. However, if the knife does not extend with sufficient momentum, the knife 44 will not immediately cut the paper upon contact, and the paper will be pushed radially against the ribs 54; as the knife teeth continue to extend, the teeth will puncture the paper (which is being held radially in place by the ribs 54) and the teeth will continue to extend into the rib cavities 55, severing a paper towel segment.

The function of the ribs 54 is particularly important when the user pulls strongly on the paper roll and causes the paper to pass quickly through the rolling assembly 18—in conventional rolling assemblies, the paper tends to become separated from the rolling surface when the paper is pulled strongly, and the knife often fails to completely sever the paper on the first revolution of the rolling drum. The knife will eventually cut through the paper when the rotation of the rolling drum has slowed sufficiently, but uncut “double sheeted” paper towel segments tend to be dispensed. In contrast, the ribs 54 of the dispenser 10 maintain the paper in position for cutting by the cutting knife 44 regardless of how strongly the user pulls the paper roll, thereby resulting in the knife 44 severing the paper into segments in each and every rotation of the cutting drum 20. Additionally, the rotational drag caused by the cutting action is sufficient to slow the rotation of the cutting drum 20 to a stop without the need of a mechanical stopper. For typical-strength pulls on the paper roll, the drag will cause the cutting drum 20 to stop after one full revolution. A particularly strong pull on the paper roll may result in the roller drum 20 rotating twice before stopping; however, the dispenser 10 ensures that a paper towel segment will be cut and dispensed in each revolution, thereby dispensing two paper towel segments instead of one double-sheeted segment. This is preferable over using a mechanical stopper, which tends to be noisy, or allowing the rolling drum and paper roll to free-spin to a stop, which tends to cause paper to un-roll and collect inside the dispenser, increasing the chances of paper jamming.

Advantageously, a cut paper sheet is provided each time paper is dispensed using the advance lever 36. The drum 20 operates to sever a paper towel segment from the sheet each time the drum completes a revolution; therefore, the user cannot “spool” paper using the advance mechanism.

This embodiment features nine ribs 54 transversely spaced across the width of the cutting roller 20; a corresponding number of knife teeth are provided that cooperate with the rib cavities 55. A different number of ribs and knife teeth can be provided within the scope of the invention so long that there are a sufficient number of ribs to hold the paper in place to ensure that the paper is cut by the knife 44. Also, the depth of the ribs 54 is selected to provide enough radial clearance for the rib cavities to receive the knife teeth.

Furthermore, the width of each rib can be varied within the scope of the invention; for example, the rib width can be increased with the rib cavity width decreased accordingly. The knife teeth widths should also be decreased accordingly to avoid the teeth coming into contact with the ribs.

According to another embodiment, the knife can comprise multiple transversely-spaced segments (not shown), instead of being a single serrated or saw-tooth blade. Also, the drum can contain multiple transversely-spaced segments. The knife and drum segments are spaced so that the ribs extend into the spaces between knife and drum segments when the knife is fully extended. The knife segments can optionally be serrated.

According to yet another alterative embodiment, the knife can comprise one or more notched segments (not shown); the notches are arranged on the segment(s) such that the ribs extend into the notches when the knife is fully extended. The knife can optionally be serrated or saw-tooth.

The operation of the dispenser 10 is now described in reference again to FIGS. 6(a) and (b). The paper roll is mounted in the roll holders 16, and the leading edge of the paper roll is fed over the top pinch roller 50, into the space in between the cutting drum 20 and the paper guide 52, past the bottom pinch roller 50, and out of slot 19. The cutting drum 20 is in a start position wherein the cutting knife 44 is retracted and in approximately the 0 degree position inside cutting drum 20. When a user pulls on the leading edge of the paper roll, the paper roll will rotate as paper is dispensed. The pinch rollers 50 keep the paper taut against the rolling surface 21, and movement of the paper also causes the cutting drum 20 to rotate. As the cutting drum 20 rotates clockwise in FIGS. 6(a) and 6(b), the knife actuator 40 travels through the cam path and causes the knife holder 42 to pivot and the knife 44 to extend out of the rolling surface 21. When the cutting drum 21 reaches the position shown in FIG. 6(b), the knife 44 is fully extended and punctures the paper. The paper is severed, and a paper towel segment is dispensed through the slot 19. At the position shown in FIG. 6(b), the return spring 32 has passed top-dead-centre, and releases its energy, rotating the cutting drum 20 back into its start position, and advancing the leading edge of the paper through the slot 19.

While the present invention has been described herein by the preferred embodiments, it will be understood to those skilled in the art that various changes may be made and added to the invention. The changes and alternatives are considered within the spirit and scope of the present invention.

We claim:

1. A paper dispensing device comprising
(a) a rotatable drum having a transversely-extending rolling surface for receiving a paper sheet thereon and a retractable knife configured to extend out of the drum through part of the drum's rotation; and
(b) a paper guide for guiding the paper sheet onto the rolling surface, and comprising a plurality of transversely-spaced ribs that are radially spaced from the rolling surface and radially overlap with the knife when the knife is fully extended.

2. A paper dispensing device as claimed in claim 1 wherein the knife is a saw tooth knife and at least some of the ribs extend into valleys of the saw tooth knife when the knife is fully extended.

3. A paper dispensing device as claimed in claim 2 wherein the knife extends from the drum at a first rotational position, becomes fully extended at a second rotational position, and retracts into the drum at a third rotational position.

4. A paper dispensing device as claimed in claim 3 wherein the ribs extend lengthwise between the first and third rotational positions, and the radial spacing varies along the length of at least one rib.

5. A paper dispensing device as claimed in claim 4 wherein the radial spacing is at a maximum at the second rotational position.

6. A paper dispensing device as claimed claim 5 wherein the radial spacing is at a minimum at the first rotational position.

7. A paper dispensing device as claimed in claim 1 wherein the knife comprises notches and at least some of the ribs extend into the notches when the knife is fully extended.

8. A paper dispensing device as claimed in claim 1 wherein the knife comprises multiple transversely-spaced segments and wherein at least some of the ribs extend into the spaces between the segments when the knife is fully extended.

9. A method of dispensing paper towel segments comprising,
(a) guiding a paper towel sheet onto a rolling surface of a cutting drum;
(b) rotating the drum and extending a knife out of the drum until the knife radially overlaps with ribs radially spaced from the rolling surface and the sheet is punctured by the knife; then (c) further rotating the drum until a paper towel segment severed from the sheet by the knife is dispensed.

10. A method as claimed in claim 9 wherein the knife extends from the drum at a first rotational position, becomes fully extended at a second rotational position wherein the knife radially overlaps with the ribs, then retracts into the drum at a third rotational position.

11. A method as claimed in claim 9 wherein the knife is saw toothed and the ribs extend into valleys of the saw tooth knife when the knife extends out of the drum.

12. A method as claimed in claim 9 wherein the knife comprises notches and at least some of the ribs extend into the notches when the knife extends out of the drum.

13. A method as claimed in claim 9 wherein the knife comprises multiple transversely-spaced segments and wherein at least some of the ribs extend into the spaces between the segments when the knife extends out of the drum.

14. A method as claimed in claim 10 wherein the ribs extend lengthwise between the first and third rotational positions, and the radial spacing varies along the length of at least one rib.

15. A method as claimed in claim 14 wherein the radial spacing is at a maximum at the second rotational position.

16. A method as claimed in claim 15 wherein the radial spacing is at a minimum at the first rotational position.
